(19) United States
(12) Patent Application Publication
(10) Pub. No.: US 2012/0300048 A1
(43) Pub. Date: Nov. 29, 2012

(54) Imaging Device and Method for Video Data Transmission Optimization

(75) Inventor: John Carson, Corona del Mar, CA (US)

(73) Assignee: ISC8 Inc., Costa Mesa, CA (US)

(21) Appl. No.: 13/480,629

(22) Filed: May 25, 2012

Related U.S. Application Data
(60) Provisional application No. 61/489,870, filed on May 25, 2011.

(51) Int. Cl. H04N 7/18

(52) U.S. Cl. 348/61; 348/E07.085

(57) ABSTRACT

A device and method for the acquisition, processing and optimized transmission of video image data. The display output of an electronic viewing device is split by means of a beam-splitting element. A split portion of the image is detected by a detector and its output digitized. Regions of interest in the split image may be identified by eye-tracking or image saliency processing means to define salient regions in the split image. The salient regions in the split image are transmitted to a remote receiver at a higher resolution than the non-salient regions in the scene whereby video transmission bandwidth is reduced and optimized.

### REFERENCE TO RELATED APPLICATIONS

This application is related to U.S. Provisional Patent Application No. 61/489,870 entitled “Night Vision Goggle Video Image Converter Attachment”, filed May 25, 2011, which is incorporated herein by reference and to which priority is claimed pursuant to 35 U.S.C. 119.

### STATEMENT REGARDING FEDERALLY SPONSORED RESEARCH AND DEVELOPMENT

N/A

### BACKGROUND OF THE INVENTION

1. Field of the Invention

The invention relates generally to the field of imaging systems and assemblies such as night vision systems, e.g., image intensification and thermal/infrared imaging systems. More specifically, the invention relates to a video image converter attachment for use in new or existing electronic viewing systems such as existing image intensifying (“I2”) tube night-vision viewing systems, that permits video data transmission to a remote receiver of selected portions of a viewed scene at a relatively high resolution and other portions of the viewed scene at a lower resolution to optimize or reduce video data transmission bandwidth.

In an alternative embodiment, the device may be configured to transmit high resolution still images or low frame rate, high resolution video as seen by the night-vision system user to a remote receiver.

2. Description of the Related Art

A very large number of prior art, head-mounted, night-vision image intensifier devices such as the PVS-14 and PVS-15 are currently fielded by or are in the inventory of military users. These “direct view” devices desirably provide upwards of 1.3 cycles/milli-radian of resolution in very low-light conditions and are superior to typical digital visible cameras in those environments.

While these prior art I2 devices currently represent some of the best available technology for high-resolution vision under low-light conditions, the user, for instance a warfighter, is hindered by the inability to share his or her view of the combat environment with others such as a squad member or with rear echelon command units who have a need for or can provide strategic or tactical assistance.

Many improvements in the above I2 prior art devices have been made including the addition of digital imagers and visible imagers that are coupled to micro-channel plates in the I2 systems, the use of broad-band SWIR imaging devices and the use of devices to optically fuse the I2 display images with a thermal image of the same scene.

While these improvements provide additional information to the warfighter, they remain incapable of transmitting high resolution I2 still or video images from a head-mounted I2 or other imaging device to other interested parties.

A major challenge in transmitting detailed video data to a remote receiver is the matter of data transmission bandwidth of video from the I2 display. For instance, at a 16-bit resolution using a 14-megapixel imager in an I2 device, data transmission at a 30 Hz refresh rate would require a transmission bandwidth in excess of 6 Gbps; a formidable transmission rate in a soldier-mounted combat environment.

What is needed is a device that permits data transmission of high resolution images of areas of interest or “saliency” to a remote observer from an electronic viewing device and that permits data transmission of lower resolution images for the balance of the image to avoid video data transmission bottlenecks.

### SUMMARY OF THE INVENTION

A device and method for the acquisition, processing and optimized transmission of video image data to a remote receiver is disclosed herein.

The display output of an electronic viewing device is optically split by means of a beam-splitting element that is disposed between an electronic viewing system display output and the user eyepiece. A split portion of the image is detected by an electronic imager or detector and the imager output digitized.

Regions of interest in the viewed scene are identified and electronically tagged by eye-tracking or image saliency processing means to define salient regions in the split portion of image or the viewed image itself. The salient regions in the scene or split portion of the image are transmitted to a remote receiver at a higher resolution than the non-salient regions in the scene whereby video transmission bandwidth is reduced and optimized.

The invention herein is well-suited for still image capture and storage of images as seen by the user of a night-vision goggle system but in the preferred embodiment, is configured to capture and transmit video image data in salient regions of the display output image of the electronic viewing device at higher resolutions than the non-salient regions for transmission to a remote data receiver, for instance, other squad members or remote commanders in a combat environment.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### DESCRIPTION OF THE DRAWINGS

FIG. 1 depicts the video data transmission device of the invention in cooperation with a prior art I2 electronic viewing device.

FIG. 2 depicts the device of the invention in a prior art I2 electronic viewing device with eye-tracking means to identify salient regions in a scene viewed by the I2 device.

FIG. 3 depicts the device of the invention in a prior art I2 electronic viewing device having electronic image saliency processing means to identify salient regions in a scene viewed by the I2 device.

The invention and its various embodiments can be better understood by turning to the following description of the preferred embodiment which is presented as an illustrated example of the invention in any subsequent claims in any application claiming priority to this application.

It is expressly understood that the invention as defined by such claims may be broader than the illustrated embodiments described below.

### DETAILED DESCRIPTION OF THE PREFERRED EMBODIMENTS

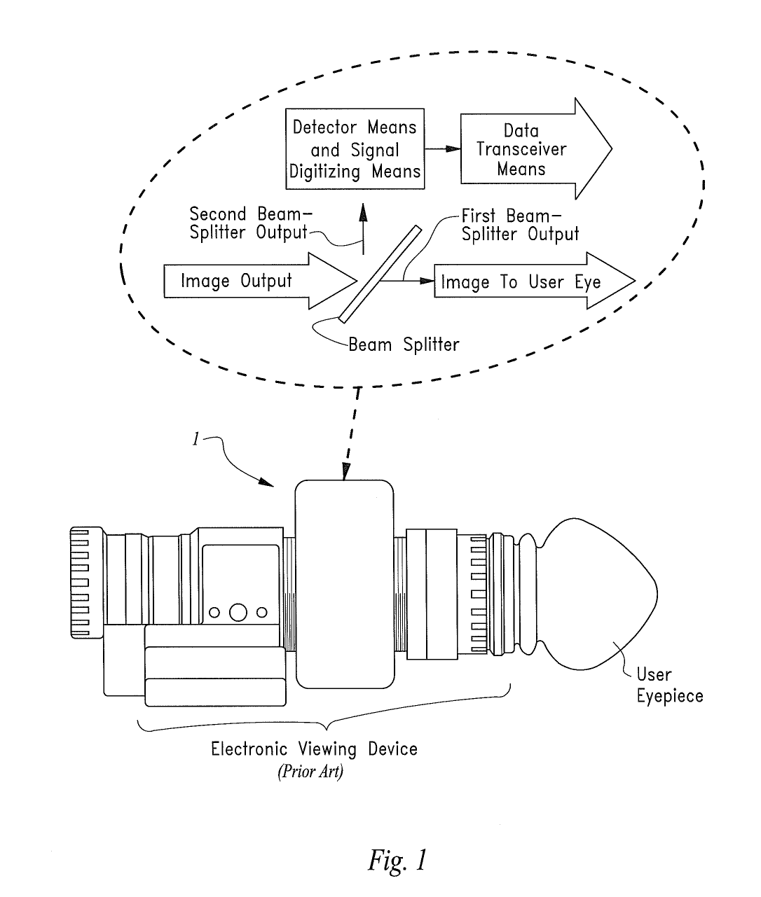

The just summarized invention may be best understood with reference to the following drawings of which FIG. 1 shows a general block diagram of the video transmission bandwidth optimized device 1 of the invention installed in a prior art I2 night vision goggle system.

To address the earlier-cited image-sharing deficiency, a video transmission bandwidth optimization device 1 is disclosed such as embodied in a fixed or removable attachment in the preferred embodiment of FIG. 1. In this embodiment, the device 1 is configured to fit or is disposed between the electronic imaging device display output (in this embodiment, an I2 display output) and the user eyepiece of the electronic viewing device to enable the transmission of high resolution I2 images to a remote receiver.

It is expressly noted that the device 1 of the invention may be provided in an integrated, single unit electronic viewing system or as an “add-in” module that is selectively attachable to, and detachable from, existing electronic viewing systems. An application may include use in prior art I2 viewing systems in the form of a compact, lightweight, low-power, video image converter attachment for use in an existing night-vision goggle system such as a PVS-14 or -15 night-vision goggle system.

In the preferred attachment embodiment of FIG. 1, the invention may generally comprise a short section or housing (e.g., ˜2 cm thick and 3.5 cm in diameter) that may be selectively installed between the PVS-x I2 tube display output and the user's eyepiece using, in this embodiment, threaded connector means.

The housing of the invention 1 is coupled to and disposed directly between the existing eyepiece of the I2 device and the intensifier tube output; preferably as a “screw-in” assembly. In this embodiment and by using a low-power, high-resolution CMOS detector element or equivalent visible imager means, device 1 may be powered by a single CR123 Li battery disposed within the housing.

In the preferred embodiment of FIG. 1, device 1 optically splits and “diverts” a portion of the I2 tube optical display output image to the detector element using beam-splitting means such as by using a folding mirror, beam-splitting prism, dichroic or partially-mirrored beam-splitting element or equivalent beam-splitting means as are well-known in the optical arts, without interfering with the user's view, for subsequent transmission to a predetermined remote receiver (e.g., a command unit).

The diverted optical output portion from the I2 night-vision goggle display is “split off” or “sampled” and is digitized and available to a soldier's standard radio set for transmission to the receivers of other members of the squad or to rear area commanders.

The folding mirror or suitable beam-splitting means may be configured to provide, in this embodiment, about a >95% transmission of the optical image from the I2 tube to the user while diverting about <5% to the high-resolution imager means (e.g., a 14 megapixel CMOS detector element).

The diverted optical image is captured by the CMOS or other visible imager means to define an electronic signal representative of the I2 display output optical image which is converted to a set of digital values. The digitized video data is received by the transceiver or transmitter element of the invention and transmitted to a predetermined remote receiver, such as the I2 device user's radio which, in turn, can transmit the electronic signal to a second receiver, such as a squad leader or command receiver.

To eliminate the requirement of a hard-wired interface to the soldier's radio, a very low-power, short-range 802.11n transceiver or equivalent IEEE 802.11 WLAN protocol transceiver means may be incorporated (e.g., with a range on the order of about 1.5 meters) into the invention housing. This serves to minimize the radio frequency “footprint” while beneficially reducing the required transmit power and reducing the possibility of cross-coupling to other soldiers' night vision devices. Equivalent data transmission means are expressly contemplated as within the scope of the invention

Turning back to the figures, in a first aspect of the invention of FIG. 1, a device for video data transmission representative of an output image of an electronic viewing system is comprised of a beam-splitter element or equivalent for providing a first beam-splitter output for viewing by the user through the user eyepiece.

Device 1 further comprises a second beam-splitter output for subsequent detection, processing and transmission by the device 1 from the display output image of an electronic viewing system. The beam-splitting element may be a folding mirror assembly, prism assembly, dichroic or partially-mirrored beam-splitting element or equivalent structure as is known in the optical arts.

Detector means in the illustrated preferred embodiment is a 14 mega-pixel CMOS imager that is provided for detecting and converting the second beam-splitter output into one or more electrical detector output signals that are representative of the second beam-splitter output.

Detector signal digitizing means is provided for converting the detector electrical signals into one or more digital values that are representative of the detector output signals from the detector means.

The device further comprises data transmission means such as an IEEE 802.11-based transceiver element or equivalent structure for wirelessly transmitting the digital values to a predetermined data receiver such as a secondary radio transmitter for subsequent transmission or to any predetermined remote data receiver.

In a second aspect of the invention, also depicted in FIG. 1, device 1 may be selectively coupled and decoupled between an electronic viewing system display output and a user eyepiece of an existing electronic viewing system.

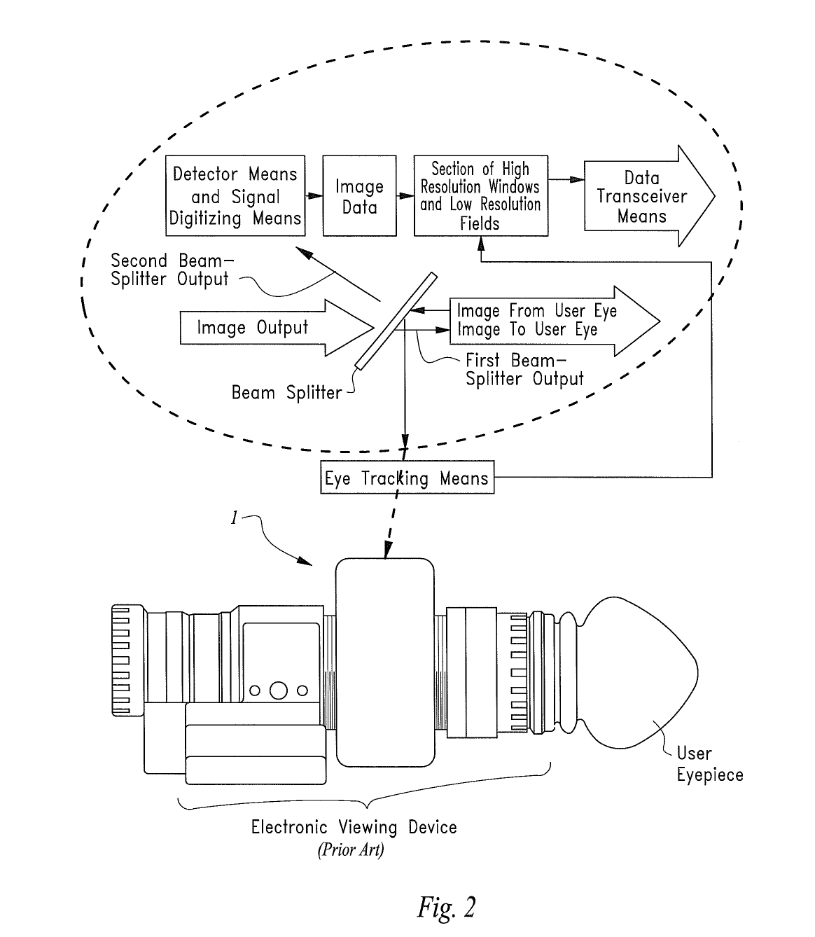

In a third aspect of the invention depicted in FIG. 2, the eyepiece may further comprise electronic eye-tracking means that is configured to measure the position of the eye of a user viewing a scene in the eyepiece. The eye-tracking means is configured to and is employed to sense and identify one or more user-fixation or “dwell” points within the viewed display output image (i.e., the first beam-splitter output) to define and electronically tag one or more saliency regions in the second beam-splitter output or in the first beam splitter output or both. Stated differently, as the user scans or “saccades” the scene in the eyepiece of the electronic viewing device, the user will tend to stop and focus on, (i.e., “foveate” on) areas of interest such as movement, color, size, or shape. The eye-tracking means, in conjunction with suitable processing circuitry, identifies areas in the scene image the user fixates on for a predetermined period, which areas are electronically tagged as “salient regions”. The salient regions may be identified as sections of high resolution windows and the non-salient regions may be identified as low resolution fields within the image data.

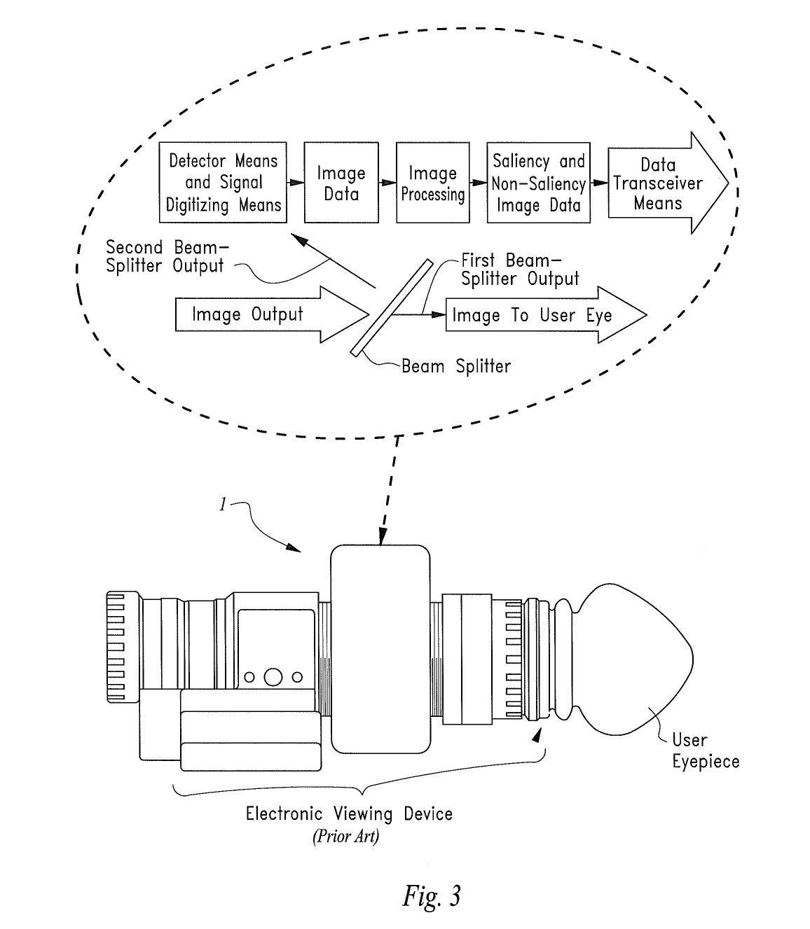

In a fourth aspect of the invention depicted in FIG. 3, electronic image processing means is provided and configured to electronically define and identify one or more saliency regions in the second beam-splitter output or first beam-splitter output or both using one or more predefined image data characteristics by means of suitable electronic processing circuitry and suitable software or firmware.

Suitable electronic image processing means is disclosed in, for instance, U.S. patent Ser. No. 12/661,537 entitled, “Apparatus Comprising Artificial Neuronal Assembly” to Carson et al. and filed on Mar. 18, 2010, the entirety of which is incorporated herein by reference.

In a fifth aspect of the invention depicted in both FIGS. 2 and 3, the data transmission means is configured to wirelessly transmit digital values representative of the saliency regions identified by either eye-tracking or image processing means or both at a predetermined first data transmission rate, e.g., a higher resolution, higher data transmission rate and to wirelessly transmit digital values that are representative of non-saliency regions in the viewed scene at a predetermined second data transmission rate to optimize data transmission bandwidth.

In a sixth aspect of the invention, a method for optimizing transmission bandwidth of data representative of an output image of an electronic viewing system is provided comprised of the step of providing an output image of an electronic viewing device such as an I2 device.

The output image is split into a first beam-splitter output and a second beam-splitter output using a beam-splitter element as above whereby the user may view the first beam-splitter output through the eyepiece of the electronic viewing device and the second beam-splitter output is directed to an electronic detector element.

The method further comprises electronically detecting and converting the second beam-splitter output into one or more electrical signals representative of the second beam-splitter output.

The electronic signals are digitized into one or more digital values and wirelessly transmitted to a predetermined remote data receiver.

In a seventh aspect of the invention, the method further comprises the step of measuring the position of the eye of a user to identify one or more user-fixation or dwell points within an output image of the display output to the electronic viewing device to define one or more saliency regions in the second beam-splitter output, the first beam-splitter output or both.

An eighth aspect of the invention, the further comprises the step of electronically processing the digital signals to identify and define one or more saliency regions in the second beam-splitter output, the first beam-splitter output or both using one or more predefined image data characteristics, e.g., using predefined image processing algorithms such as edge detection, motion detection, color, contrast, Gabor filtering, Reichardt filtering or any desired selected image processing or image pixel analysis algorithm or algorithms. The salient regions may be identified as sections of high resolution windows and the non-salient regions may be identified as low resolution fields within the image data.

In a ninth aspect of the invention, the method may further comprise the step of transmitting digital values representative of the saliency regions identified using eye-tracking or electronic image saliency processing means at a predetermined first data transmission rate and transmitting digital values that are representative of non-saliency regions at a predetermined second data transmission rate to a predetermined data receiver to optimize data transmission bandwidth.

Device 1 may further be provided with the ability to select either streaming video at, for instance, standard NTSC resolution or a low-speed video/snapshot feed with very high resolution. In one embodiment, the attachment is configured to provide numeric overlay of position or other data.

The following claims are intended not only to cover the specific embodiments disclosed, but also to cover the inventive concepts explained herein with the maximum breadth and comprehensiveness permitted by the prior art.

The words used in this specification to describe the invention and its various embodiments are to be understood not only in the sense of their commonly defined meanings, but to include by special definition in this specification, structure, material or acts beyond the scope of the commonly defined meanings. Thus, if an element can be understood in the context of this specification as including more than one meaning, then its use must be understood as being generic to all possible meanings supported by the specification and by the word itself.

The definitions of the words or elements are defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements or that a single element may be substituted for two or more elements.

Insubstantial changes from the subject matter as viewed by a person with ordinary skill in the art, now known or later devised, are expressly contemplated as being equivalent. Therefore, obvious substitutions now or later known to one with ordinary skill in the art are defined to be within the scope of the defined elements.

The inventions are thus to be understood to include what is specifically illustrated and described above, what is conceptually equivalent, what can be obviously substituted and also what essentially incorporates the fundamental idea of the invention.

Although elements may be described above as acting in certain combinations, it is to be expressly understood that one or more elements from a combination can, in some cases be excised from the combination and that the combination may be directed to a sub-combination or variation of a sub combination.

I claim:

1. A device for video data transmission representative of a display output image of an electronic viewing system comprising:
a beam-splitter element for providing a first beam-splitter output and a second beam-splitter output from a display output image of an electronic viewing system,
detector means for converting the second beam-splitter output into one or more electrical signals representative of the second beam-splitter output,
signal digitizing means for converting the electrical signals into one or more digital values, and,
data transmission means for transmitting the digital values to a predetermined data receiver.

2. The device of claim 1 coupled between an electronic viewing system display output and a user eyepiece of the electronic viewing system.

3. The device of claim 2 wherein the eyepiece further comprises eye-tracking means configured to measure the position of the eye of a user to sense and identify one or more user-fixation points within the second beam-splitter output to define one or more saliency regions.

4. The device of claim 2 further comprising electronic image saliency processing means configured to identify one or more saliency regions in the second beam-splitter output using one or more predefined image data characteristics.

5. The device of claim 3 wherein the data transmission means is configured to transmit digital values representative of the saliency regions at a predetermined first data transmission rate and to transmit digital values that are representative of a non-saliency region at a predetermined second data transmission rate.

6. The device of claim 4 wherein the data transmission means is configured to transmit digital values representative of the saliency regions at a predetermined first data transmission rate and to transmit digital values that are representative of a non-saliency region at a predetermined second data transmission rate.

7. A method for optimizing transmission bandwidth of data representative of an output image of an electronic viewing system comprised of the steps of:
providing a display output image of an electronic viewing device,
splitting the display output image into a first beam-splitter output and a second beam-splitter output using a beam-splitter element,
detecting and converting the second beam-splitter output into one or more electrical signals representative of the second beam splitter output,
digitizing the electrical signals into one or more digital values, and,
transmitting the digital values to a predetermined data receiver.

8. The method of claim 7 further comprising the step of measuring the position of the eye of a user to identify one or more user-fixation points to define one or more saliency regions in the second beam-splitter output.

9. The method of claim 7 further comprises the step of electronically processing the digital signals to identify one or more saliency regions in the second beam-splitter output using one or more predefined image data characteristics.

10. The method of claim 8 further comprising the step of transmitting digital values representative of the saliency regions at a predetermined first data transmission rate and transmitting digital values that are representative of a non-saliency region at a predetermined second data transmission rate to a predetermined data receiver.

11. The method of claim 9 further comprising the step of transmitting digital values representative of the saliency regions at a predetermined first data transmission rate and transmitting digital values that are representative of a non-saliency region at a predetermined second data transmission rate to a predetermined data receiver.
